(19) United States
(12) Patent Application Publication
(10) Pub. No.: US 2015/0132191 A1
(43) Pub. Date: May 14, 2015

(54) LASER RING FOR ERADICATING POLLUTANTS

(71) Applicants: Thomas J. Sindle, Staten Island, NY (US); Jacqueline A. Sindle, Staten Island, NY (US); Wayne A. Sindle, Staten Island, NY (US)

(72) Inventors: Thomas J. Sindle, Staten Island, NY (US); Jacqueline A. Sindle, Staten Island, NY (US); Wayne A. Sindle, Staten Island, NY (US)

(21) Appl. No.: 14/539,209

(22) Filed: Nov. 12, 2014

Related U.S. Application Data
(60) Provisional application No. 61/902,969, filed on Nov. 12, 2013.

(51) Int. Cl. B01D 53/92

(52) U.S. Cl. CPC B01D 53/92
USPC 422/168

(57) ABSTRACT

A laser ring is presented for mounting on or incorporating into a power plant generating pollutant gases as byproducts. The laser ring includes a ring housing receiving the gases and a laser beam which is reflected many times by the housing into the gases to generate a hot energy field and remove the pollutants. The ring can be adapted to operate on motor vehicles, airplanes, stacks of power plants, etc.

### RELATED APPLICATIONS

This application claims priority to U.S. Provisional Patent application Ser. No. 61/902,969 filed Nov. 12, 2013 incorporated herein in its entirety.

### BACKGROUND OF THE INVENTION

1. Field of Invention

This invention pertains to a system for treating combustion byproducts from various power plants, such as internal combustion engines and the like. More particularly, these byproducts are passed through a concentrated laser beam arranged and constructed to eliminated any combustible and other undesirable compounds therefrom and release the same into the atmosphere as harmless, non-polluting compounds.

2. Description of the Prior Art

Various activities taking place in our society, whether commercial, manufacturing or recreational activities, all make use of power plants that generate energy in one form or another, usually from some kind fuel, such as fossil fuel. For example these power plants may include large electrical generators generating electricity, internal combustion engines on motor vehicles, etc. Typically, an undesirable result of the operation of these power plants is the production of various byproducts which include pollutants that are harmful to the environment. Therefore the power sources are provided with various means of reducing these pollutants, such as catalytic converters, mechanical filters, chemical scrubbers, etc. These means increase the cost of building and running the power plants, and in addition, are frequently not very efficient.

Accordingly, there is a need for a system that can be used in various types of power plants that can reduce harmful pollutants quickly, effectively and inexpensively.

### SUMMARY OF THE INVENTION

The present invention provides a system of reducing and even eliminating pollutants generated by typical power plants. The system includes a plurality of lasers arranged to generate a high energy field. Byproducts from a power plant are forced through the field and the pollutants from these products are burned up leaving harmless gases or particles. As indicated above, prior means for reducing pollutants were inefficient, expensive and slow as compared to the present system.

In one exemplary embodiment, the catalytic converter of the exhaust pipe in a motor vehicle is replaced with a laser ring which has an oscillating pulsed laser gun pointed inwardly into the reflective laser ring generating a high temperature energy field. Exhaust gases from the internal combustion engine pass through this field and are burned up.

Advantageously the laser is moved in an oscillating sweeping motion to generate a high temperature field,

Similar structures are used in industrial stacks and other structures leading combustion gases and other byproducts from respective power plants.

### BRIEF DESCRIPTION OF THE DRAWINGS

FIG. 1 is a plan view of a vehicle with a catalytic converter shown as prior art.

FIG. 2 is a plan view of a vehicle with our laser ring replacing the catalytic converter in the exhaust system.

FIG. 3 is an enlarged view showing a part of the exhaust pipe with a laser ring with its laser gun in place.

FIG. 4 is a across-sectional view (taken along lines 4-4 of FIG. 3), showing how the laser's beam enters the chamber and deflects around the ring.

FIG. 5 is an enlarged view showing the full laser wall.

FIG. 6 is an enlarged fragmentary view, showing part of the laser ring and how it is constructed; also shown is the hot laser wall that is reflected off of the highly-polished self-cleaning surface of the ceramic ring. It also shows harmful particles being destroyed. (Taken along lines 6-6 of FIG. 3.)

FIG. 7 shows a laser gun with a normal, narrow beam.

FIG. 8 shows a laser gun with a wide beam.

FIG. 9 shows a cross-sectional view (taken along lines 9-9 of FIG. 8), showing how, by using a spreading lens, you can transform a narrow laser beam into a wide laser beam.

FIG. 10 shows an enlarged cross-sectional view that shows you can also use two laser guns to bring their beams together to create a different strength beam that will come out through a spreading lens.

FIG. 11 shows an enlarged cross-sectional view showing a multi convex ceramic surface laser ring with a reflective surface and a field of interlaced laser beams.

FIG. 12 shows the reflective surface of FIG. 11 with part of its full laser wall.

FIG. 13 shows an enlarged cross-sectional view showing a multi concave ceramic surface laser ring with a reflective surface and a field of interlaced laser beams.

FIG. 14 shows the reflective surface of FIG. 13 with part of its full laser wall.

FIG. 15 shows an enlarged sectional view of the wall with triangular peaks instead of convex or concave ribs.

FIG. 16 shows a greatly enlarged view with small perturbations or subpeaks on the ceramic surfaces.

FIG. 17 shows an arrangement for an exhaust pipe with eight laser rings.

FIG. 18 shows a view similar to the one in FIG. 6 but fitted with two rings, one containing a hot laser and the other containing a cold laser for removing different types of pollutants and/or other harmful particles from the exhaust of a power plant.

FIG. 19 shows an arrangement with two laser guns one behind the other operating independently.

FIG. 20 shows an embodiment of the invention in which the laser ring has a smooth inner surfaces, with its laser beams.

FIG. 21 shows a truck with vertical exhaust pipes including respective laser rings;

FIG. 22 shows a partial view of an airplane wing with jet engines equipped with laser rings;

FIG. 23 shows a somewhat diagrammatic view of a factory with a smoke stack equipped with a laser ring.

FIG. 24 shows a top view of the smoke stack of FIG. 23 showing in more detail the laser ring;

FIGS. 25, 26 and 27 show details of the laser ring for the smoke stack and how it is attached to said smoke stack with FIG. 26 taken along lines 26-26 on FIG. 25 and FIG. 27 being a sectional view of FIG. 26 taken along lines 27-27.

FIG. 28 shows a heat resistant belt which holds the many ceramic reflective blocks shown in FIG. 25.

FIG. 29 shows a sheet metal that can hold the laser ring belt and can be cut to fit various sized smoke stacks.

FIGS. 30-32 show details of how the laser ring for stack is assembled and installed.

FIGS. 33-35 show details of a mechanism for oscillating a laser on the exhaust of a motor vehicle.

FIGS. 36-38 show details of a mechanism for oscillating a laser on the exhaust of an airplane or smokestack.

FIG. 39 shows another embodiment of a laser ring for a motor vehicle.

### DETAILED DESCRIPTION OF THE INVENTION

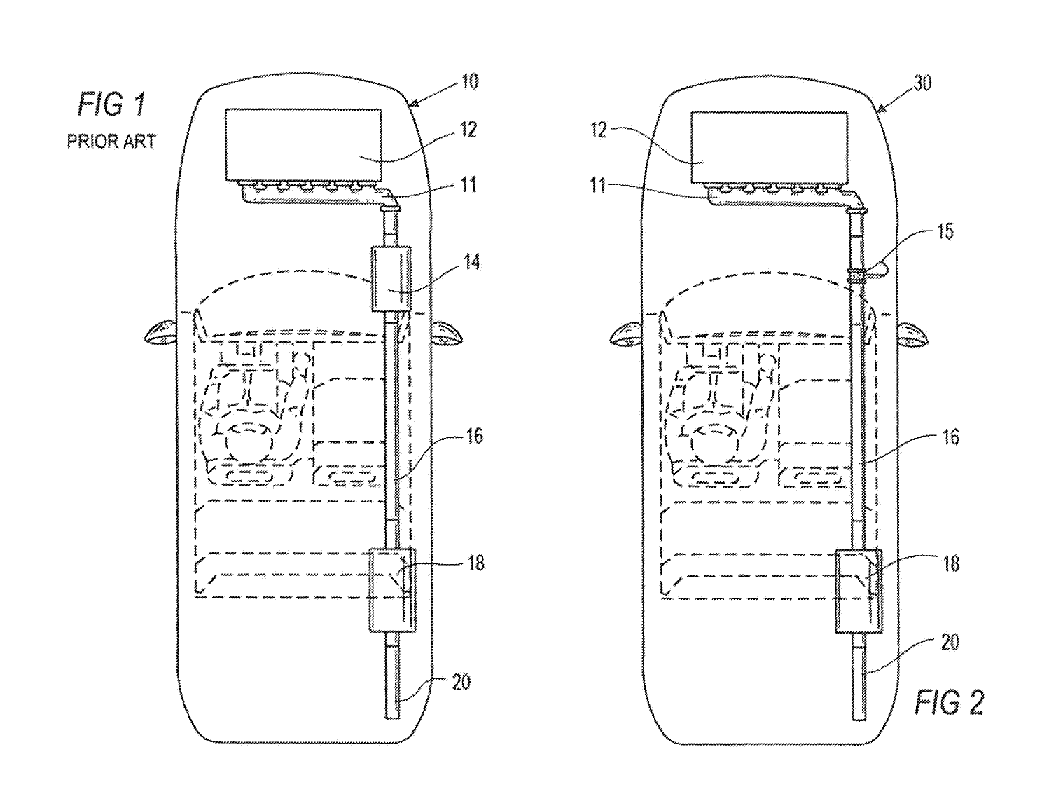

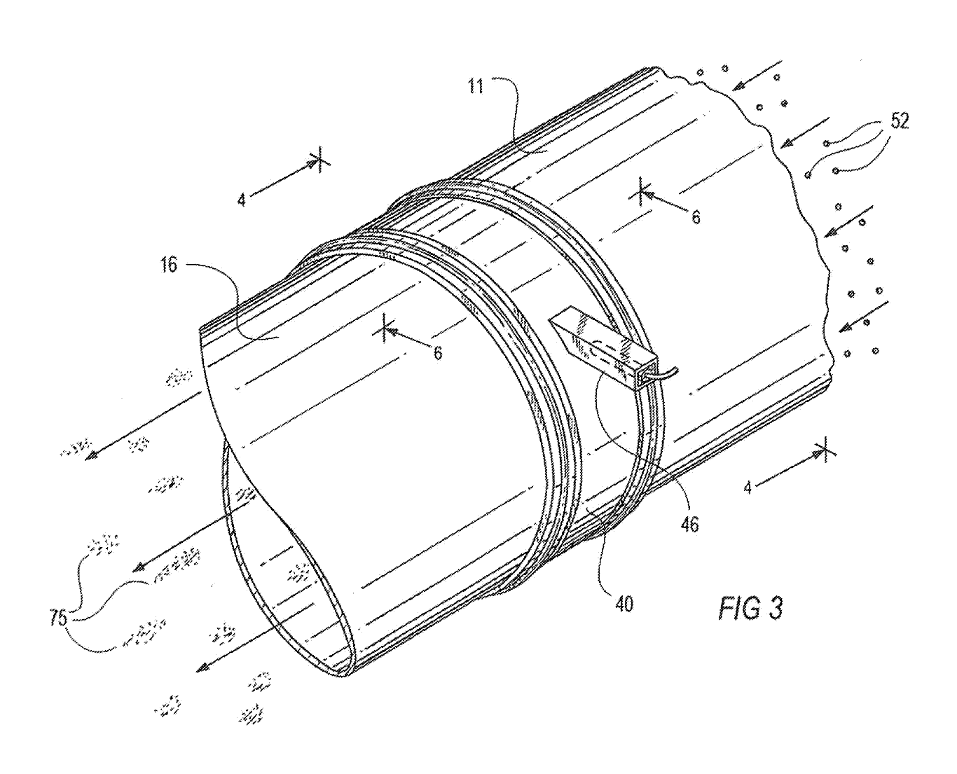

Referring first to FIG. 1, a conventional motor vehicle 10 includes a vehicle engine 12 with a manifold pipe 11 leading a catalytic converter 14. The engine 12, typically an internal combustion engine, generates noxious and pollutant gases and other matter 52 (FIG. 3) which are at least partially scrubbed by converter 14 before being exhausted through exhaust pipe 16, muffler 18 and tail pipe 20.

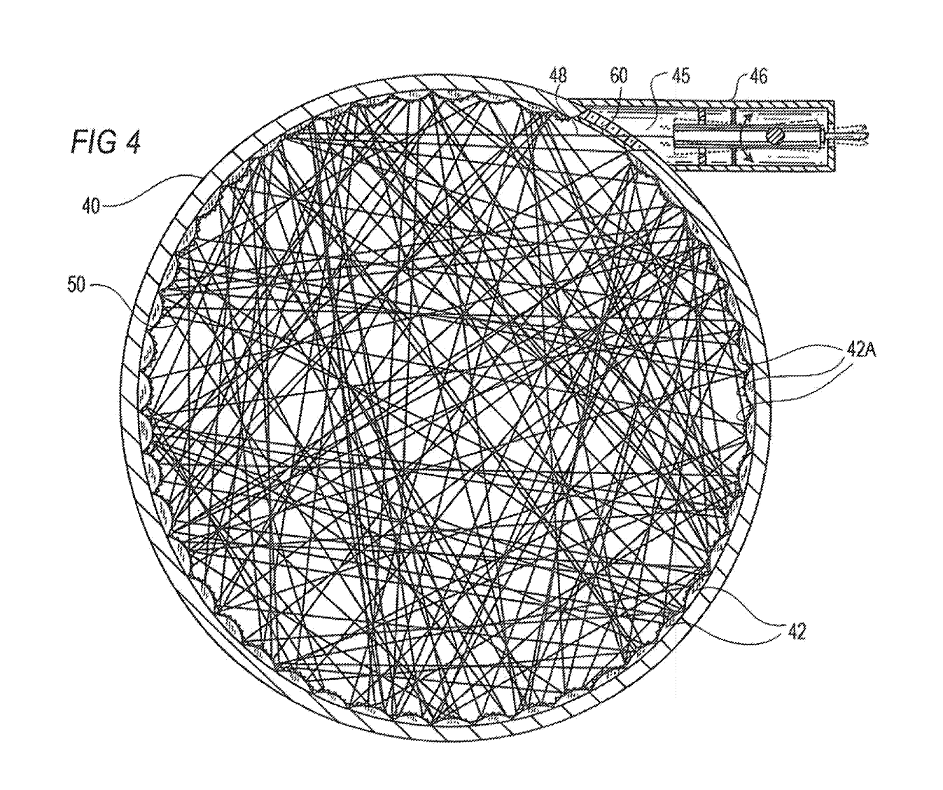

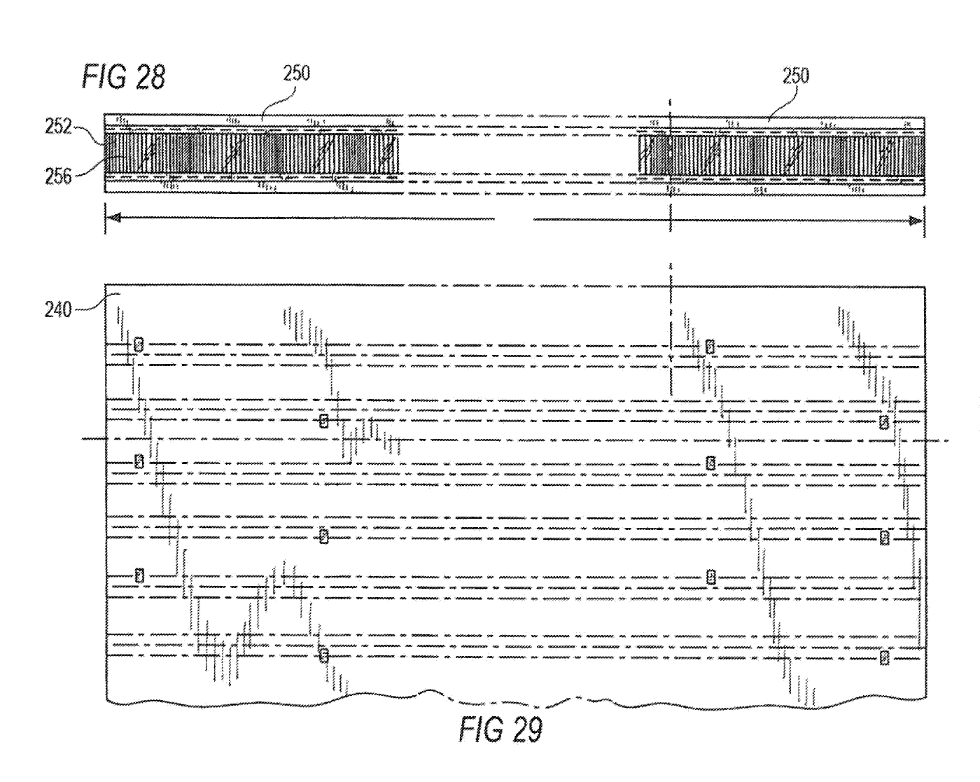

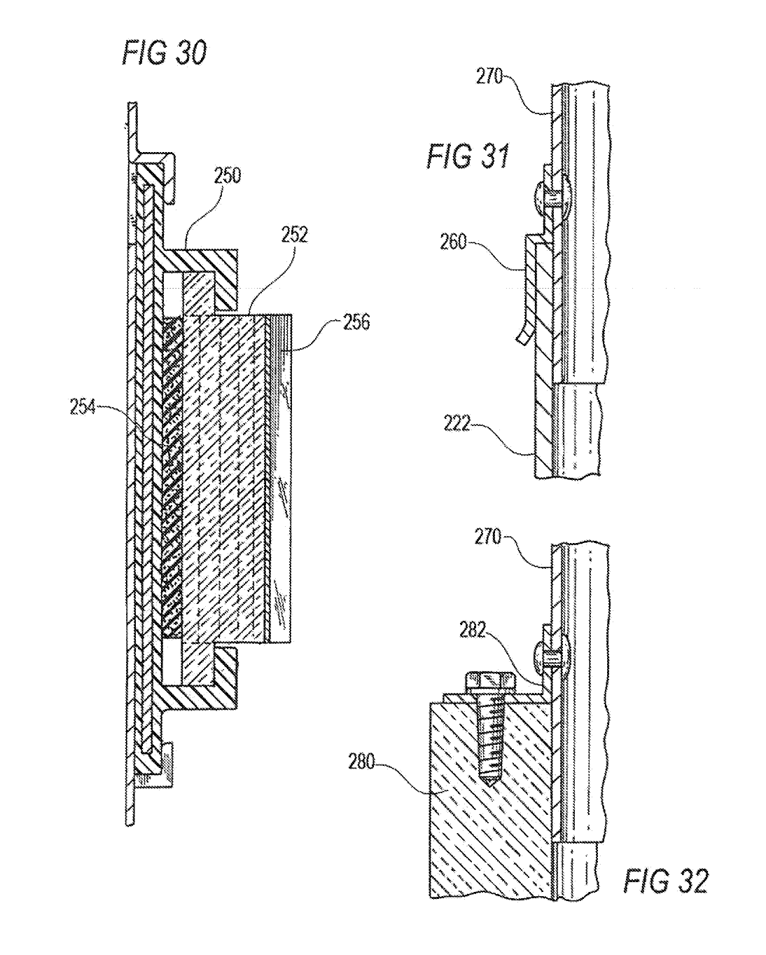

An improved vehicle 30 is shown in FIGS. 2-28. In vehicle 30, instead, or in addition to catalytic converter 12, a laser ring 15 is also provided. The ring 15 includes a laser ring housing 40 with outer cylindrical surface 40A and an inner surface 42 made of a ceramic self-cleaning material that can withstand very high temperatures without being distorted or destroyed. The inner surface includes a plurality of ribs 42A, A laser gun 46 shoots a laser beam 48 through an aperture 45. The beam 48 is reflected numerous times around ring 40 by ribs 42A to generate a somewhat planar high intensity field 50. Exhaust gases and other matter 52 from engine 12 pass through this field 50. The laser beam 48 is either continuous or pulsating and has an intensity, pulsation frequency and wavelength selected to burn up the gases and other matter 52 into harmless vapors, gases and dust 75.

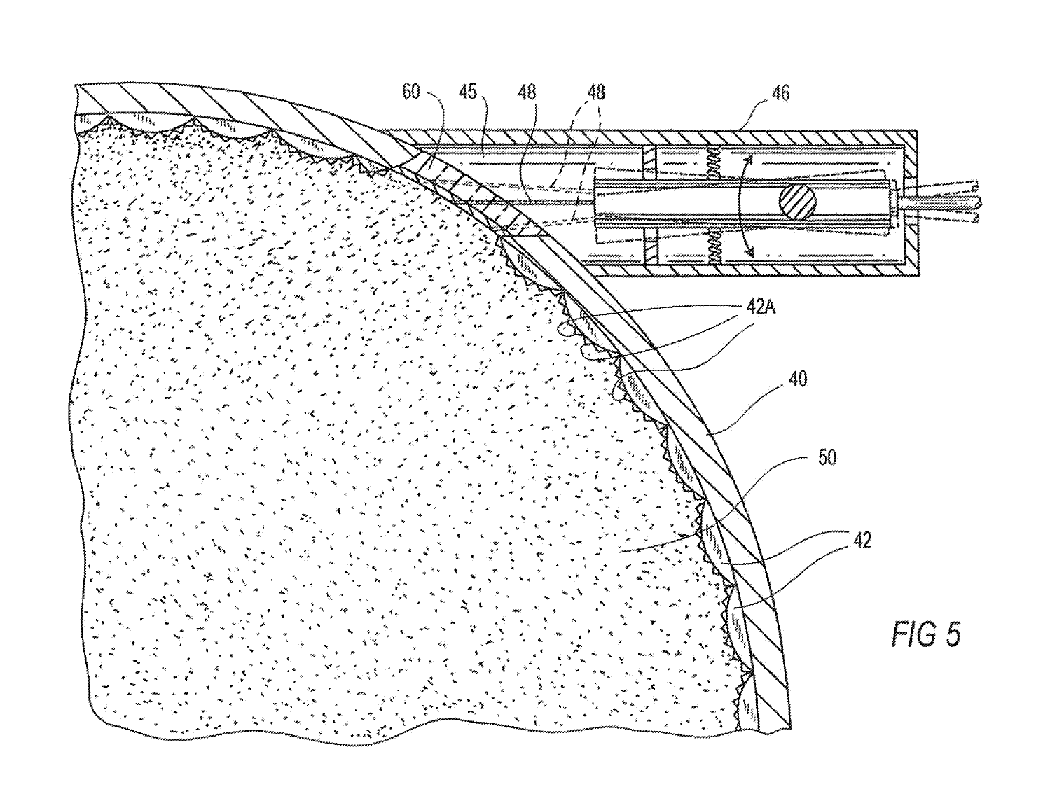

In the embodiment of FIG. 5 the aperture 45 is covered by a one way mirror 60 selected to pass the beam 48 into the ring 40 but prevent it from exiting.

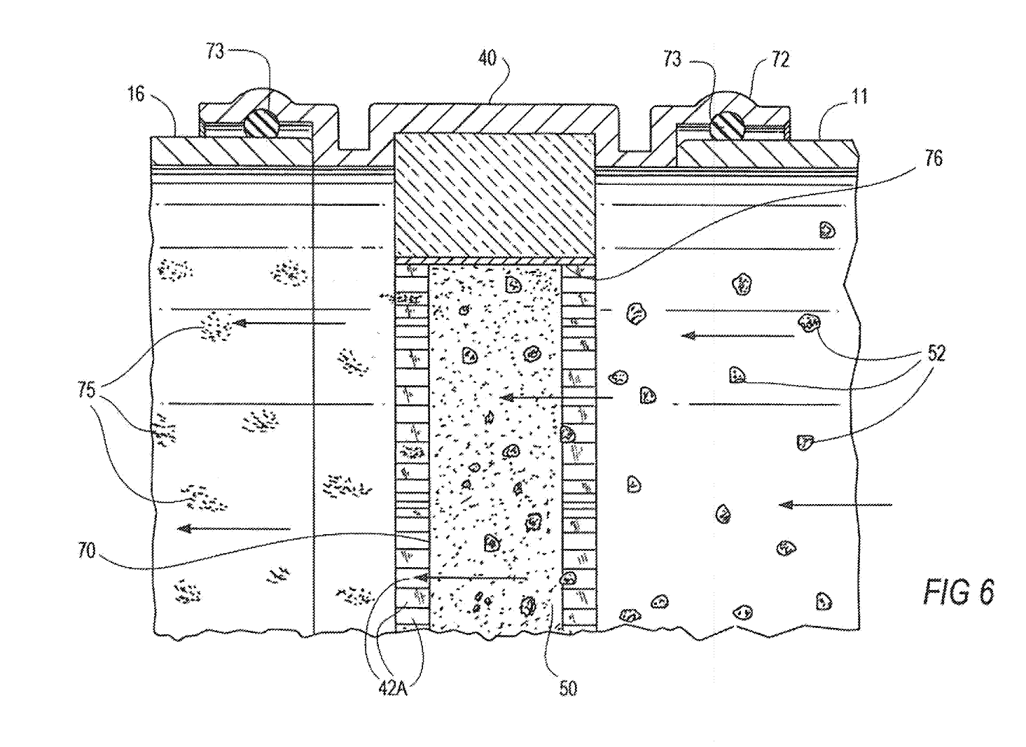

FIG. 6 shows details of how a laser ring may be incorporated into an exhaust system. In this Figure, the laser ring 40 is provided with a back telescoping end 72 receiving the end of exhaust pipe 16. An O-ring 73 is used to insure that gases do not escape from the system.

A front end 72 is used to connect the laser ring 40 to the end of the manifold pipe 11. Another O-ring 73 is used to prevent gas from escaping prematurely, In this embodiment, the interior 76 of the laser ring is smooth (e.g., cylindrical) and highly reflective.

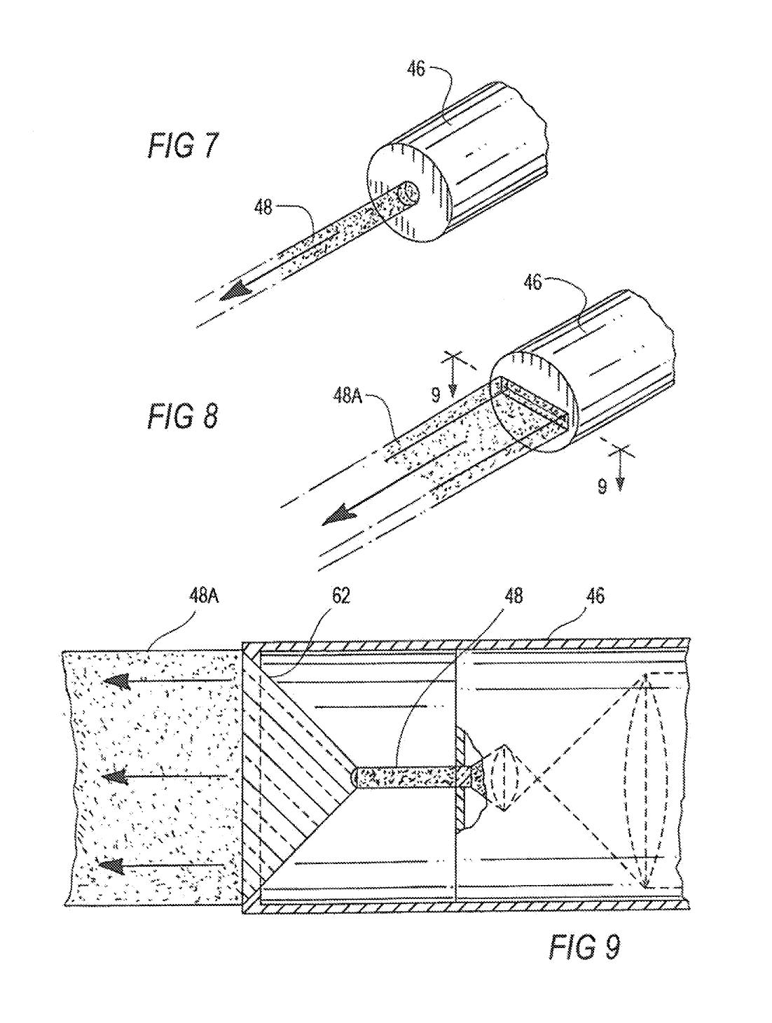

Beam 48 could be a narrow beam, or wide beam 48A as shown in FIGS. 7 and 8. For a wide beam, a spreading lens 62 may be used in gun 46 (FIG. 9).

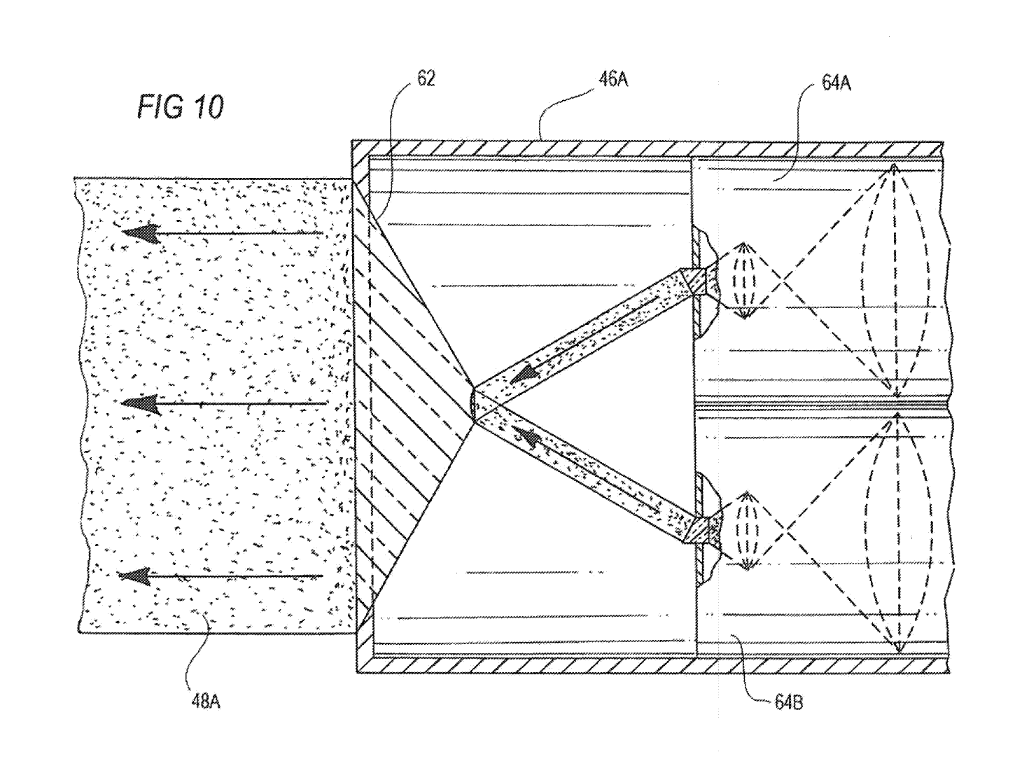

In FIG. 10 a modified laser gun 46A is shown with two lasing sources 64A, 64B. The beams from these sources are combined into a single wide laser beam 48A by lens 62.

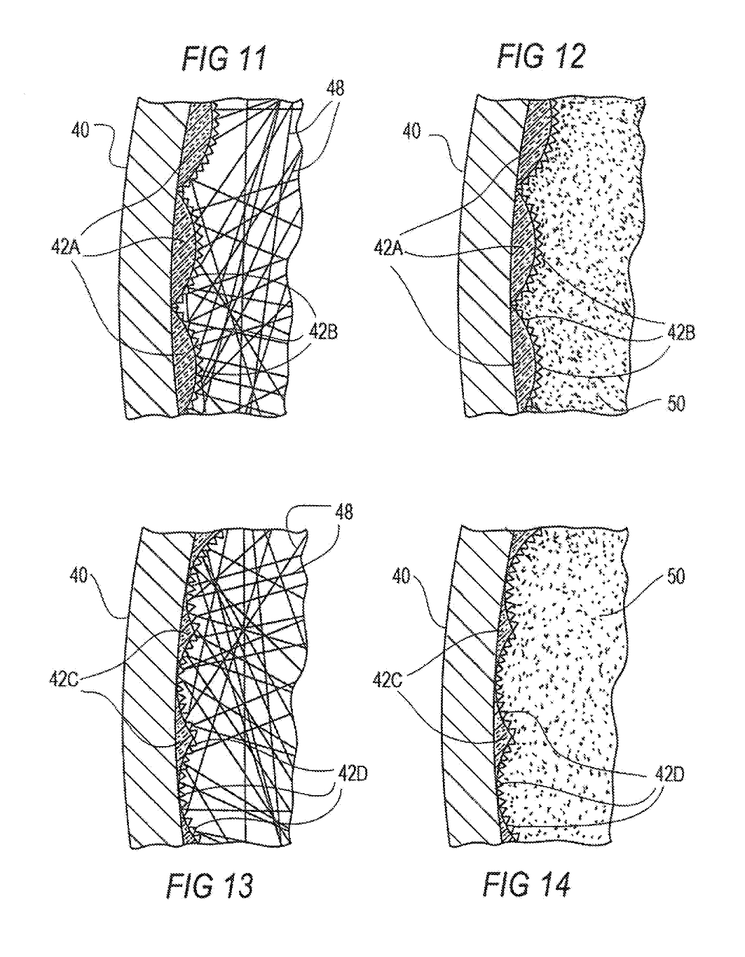

In FIGS. 11 and 12, the convex ribs 42A are shown with small perturbations 42B. FIGS. 13, 14 show the inner surface of the ring with concave surfaces 42C instead of the ribs 42A. The surfaces 42C can be formed with small perturbations 42D.

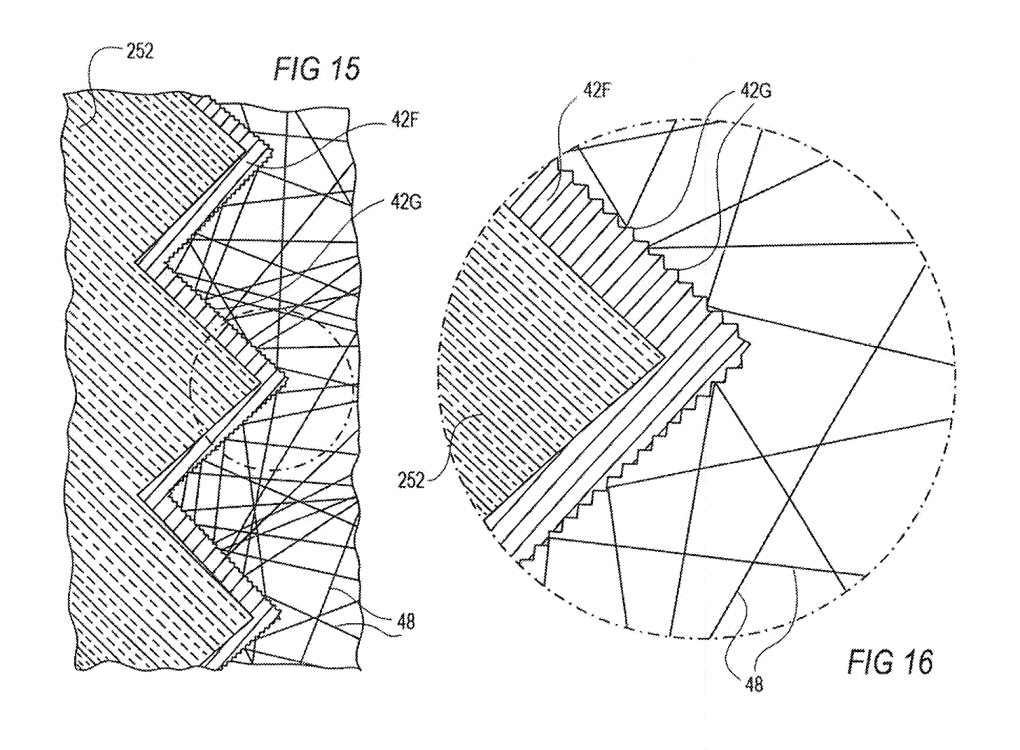

In FIGS. 15 and 16 the inner surface of the laser ring is shown with triangular or saw-tooth shaped reflecting elements 42F instead of concave or convex elements. The elements 42F may be provided with small perturbations or subpeaks 42G.

All these configurations are designed to insure that the laser beams directed into the laser ring by the laser gun is reflected over and over again to cover the cross-sectional area of the ring as much as possible thereby insuring that the exhaust gases passing there through are treated and cleaned thoroughly.

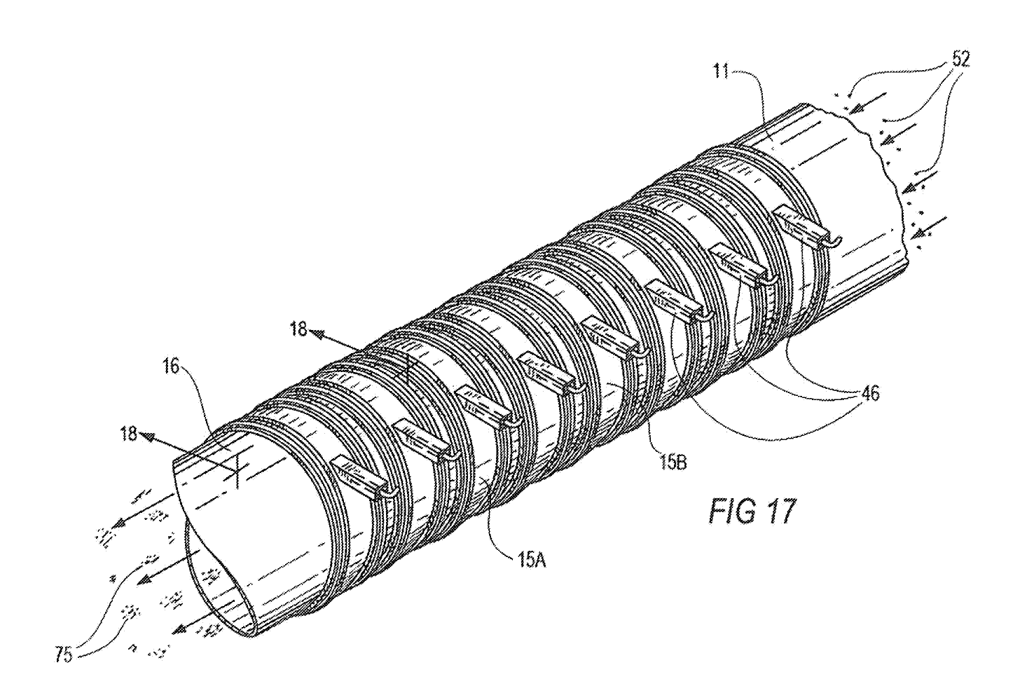

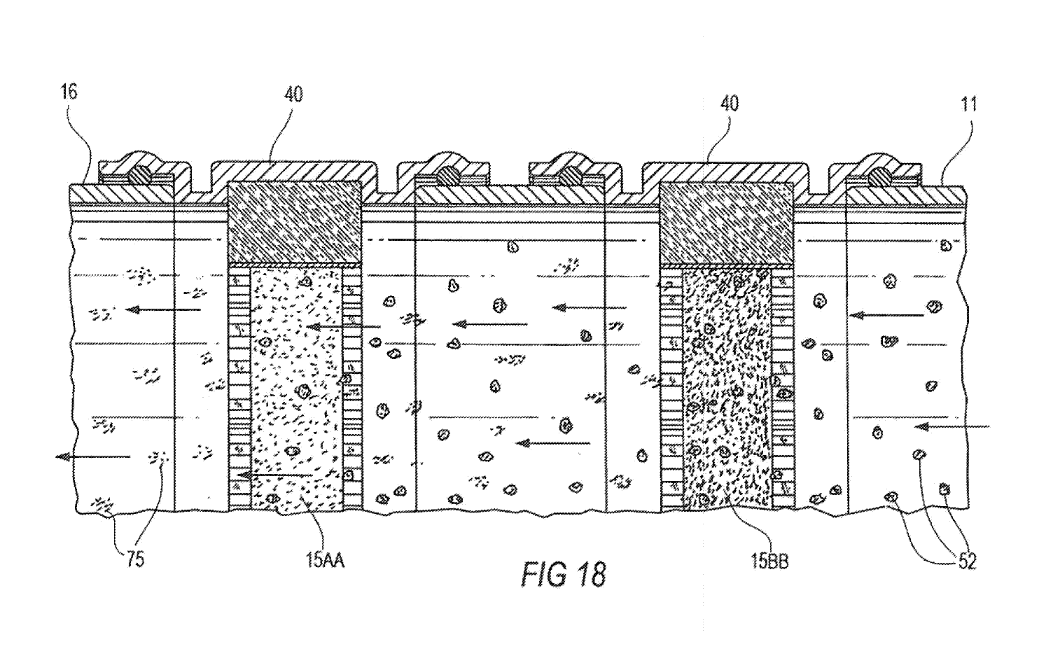

In FIG. 17, several laser rings 15A, 15B are provided. The lasers within the rings may be operating at different temperatures and other conditions to remove and/or treat different pollutants and particulate matters within the exhaust from the power plant. The number of laser rings depends on the particular installation, type of power plant, type of pollutants in the exhaust, etc. FIG. 17 shows a system of eight serial laser rings. FIG. 18 shows a cross sectional view of an exhaust system with two laser rings, a hot laser ring 15AA and a cold laser ring 15BB.

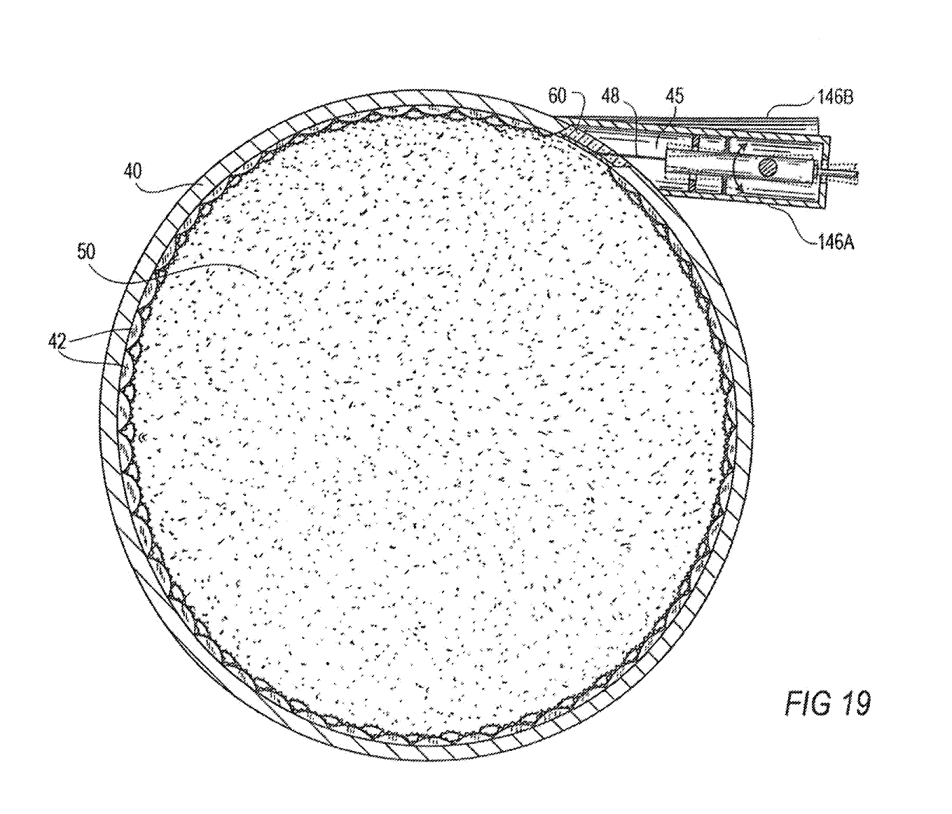

FIG. 19 shows a cross sectional view of a laser ring 140 with two laser guns 146A, 146B. The two guns can be pivoted sideways simultaneously or independently with laser gun 146B being behind laser gun 146A to generate a concentrated high energy field as described.

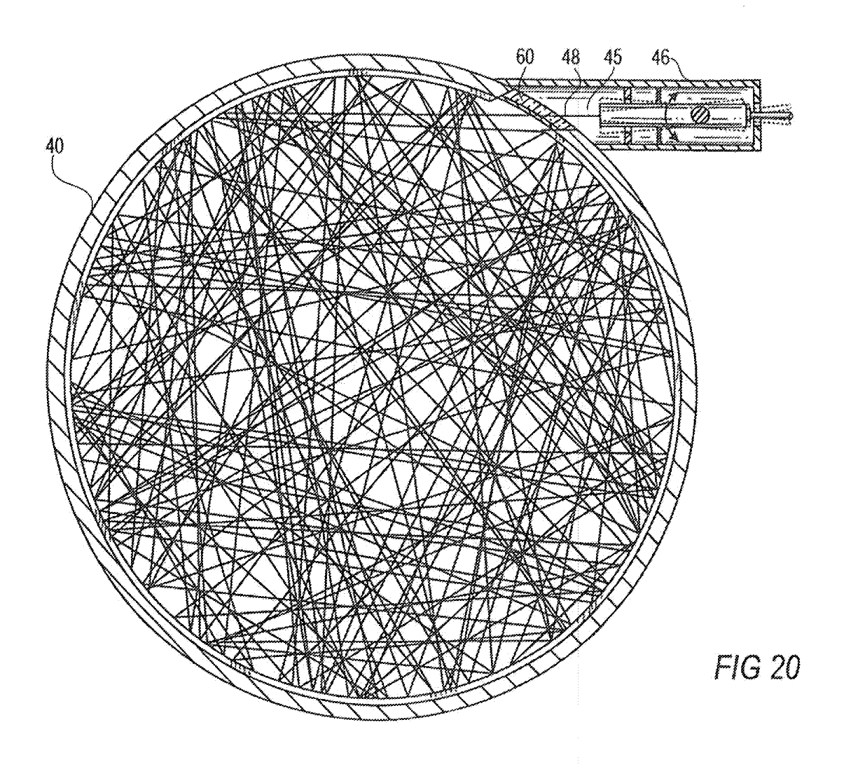

FIG. 20 show an embodiment of the invention in which the laser ring has a smooth inner surface.

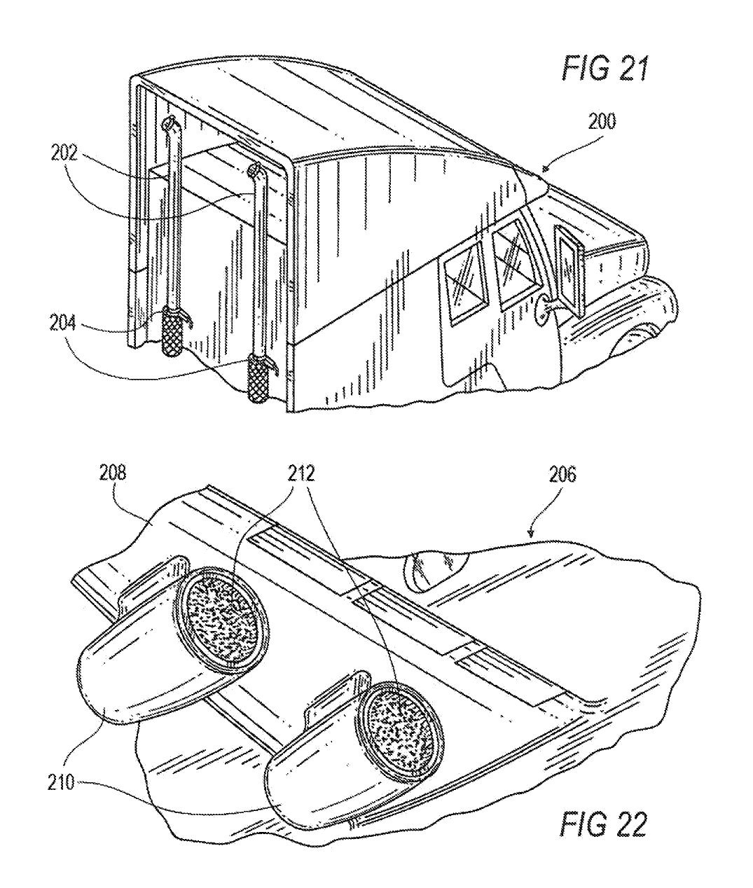

FIG. 21 shows a truck 200 with a pair of exhaust pipes 202 having laser rings 204 constructed as discussed above.

FIG. 22 shows an airplane 206 with a wing 208 having jet engines 210 with laser rings 212 constructed as discussed above.

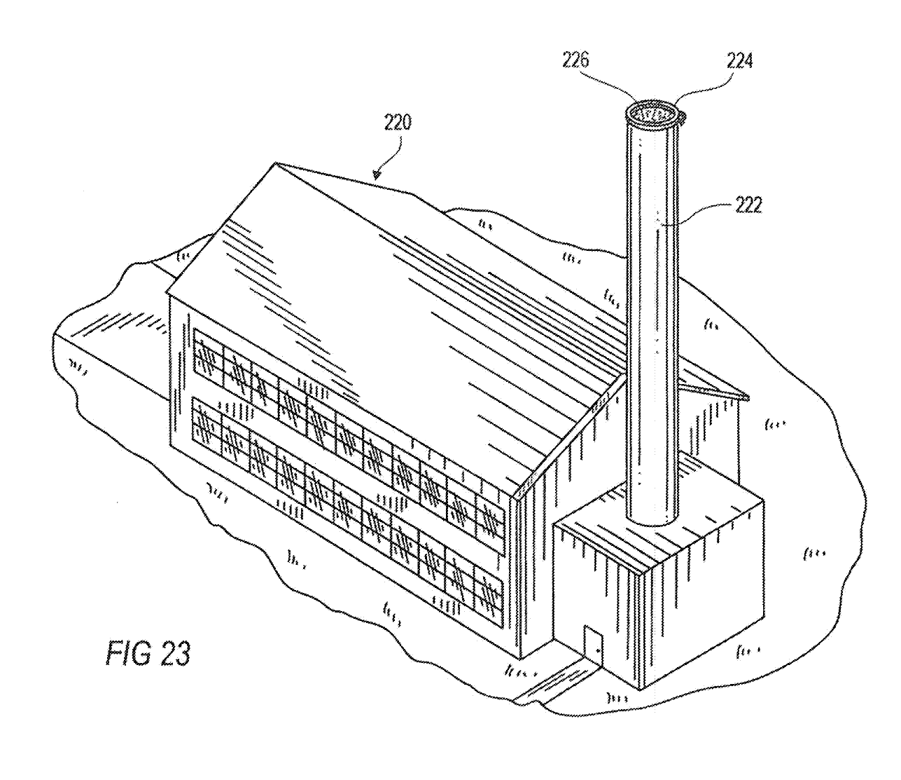

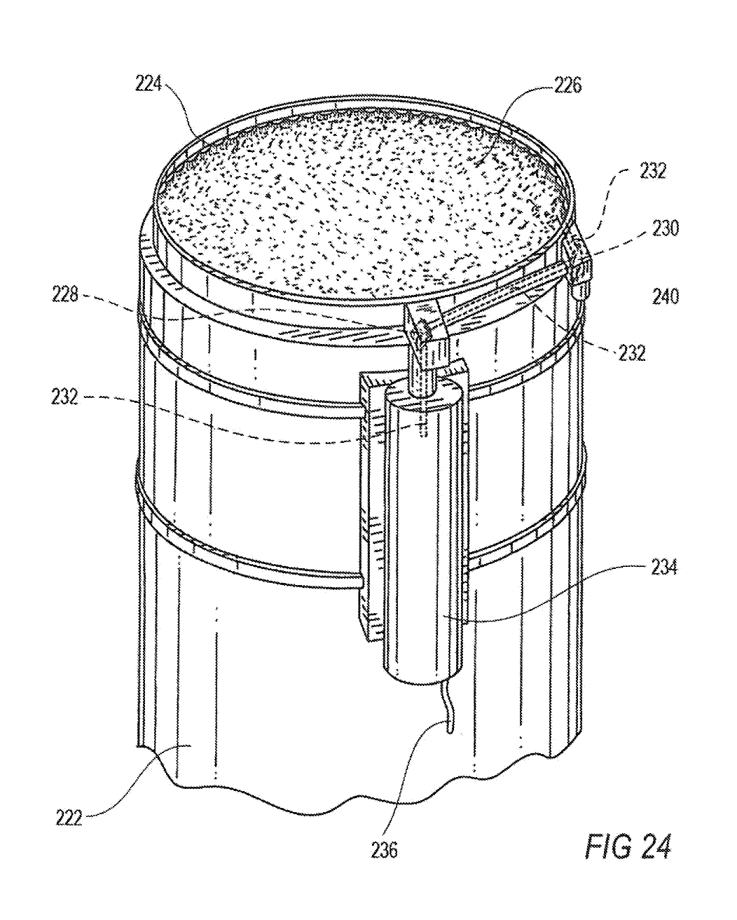

FIG. 23 show a factory 220 with smoke stack 222 equipped with a laser ring 224. As shown in FIG. 24, the ring 224 includes a laser wall 226 receiving from mirrors 228 230 a laser beam 232 from a laser gun 234 receiving power from a line 236. A motor 240 oscillates the mirror 230 to direct the laser beam at different directions for reflection by wall 226.

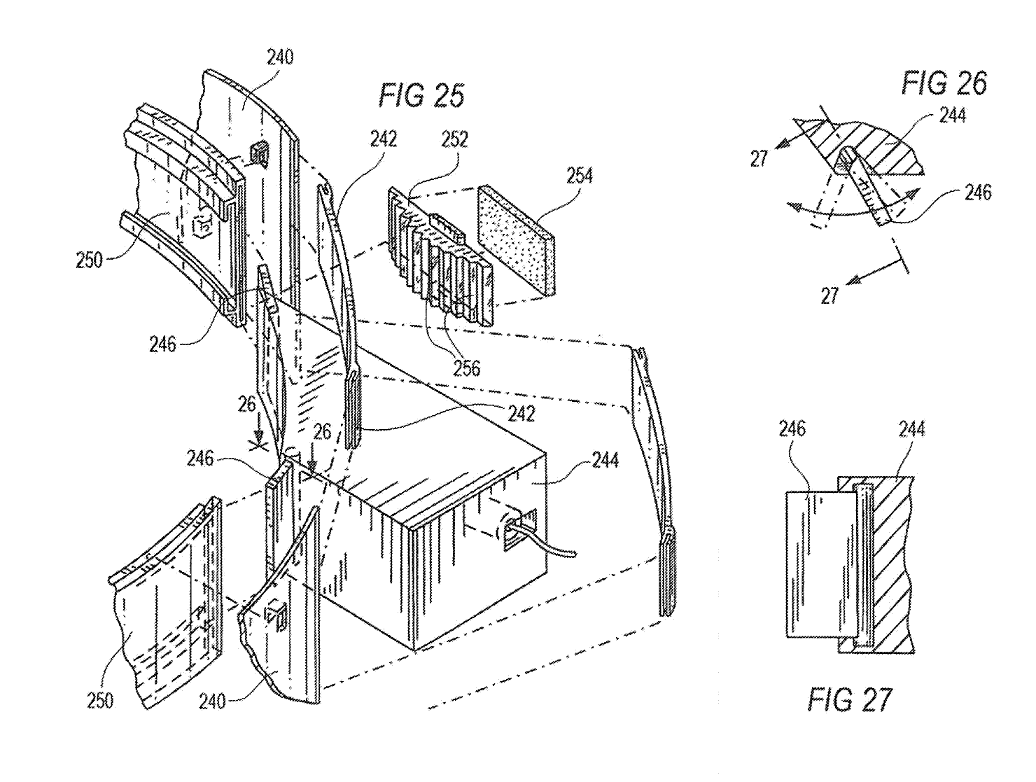

As shown in FIGS. 25-27 the ring in FIG. 24 can be assembled from an outer sheath formed of sheet metal 240 joined at the edges by an upper spacer wall 242 arranged to support the laser gun housing 244. The laser gun housing 244 is attached to the outer wall by alignment wings 246.

A heat resistant plastic belt 250 is attached on an inner surface of the outer wall 240. A plurality of ceramic reflective blocks 252 are attached to the plastic belt 250 by rubber pads 254. The blocks 252 have highly reflective complex inner surfaces 256 for reflecting the laser beam. As seen in FIGS. 31 and 32, the stack 222 may have a thin metal sheet wall 270, in which case the laser ring is attached to the wall 270 by metal clips 260.

Alternatively, a ceramic stack 280 having a mounting bracket 282 that holds the liner 270 to which the ring is attached.

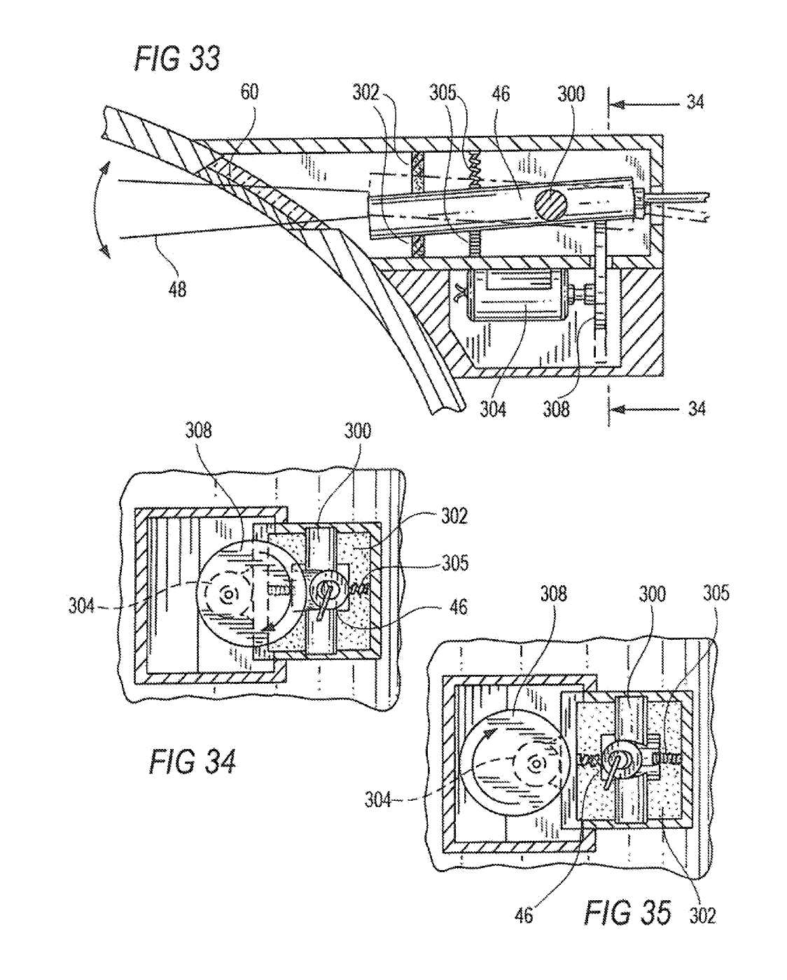

As previously mentioned, advantageously the laser gun within the laser ring is oscillated to selectively direct the laser beam at different angles. As shown in FIGS. 33-35, this function may be implemented by mounting the laser gun 46 on a pivot point 300. The gun is maintained in a predetermined angular position by springs 305 and rubber bumpers 302 are used to limit the movement of the gun 46. A motor 304 is disposed below the gun 46 and rotates an off center cam 308. As the cam 308 is rotated it causes the gun 46 to oscillate back and forth.

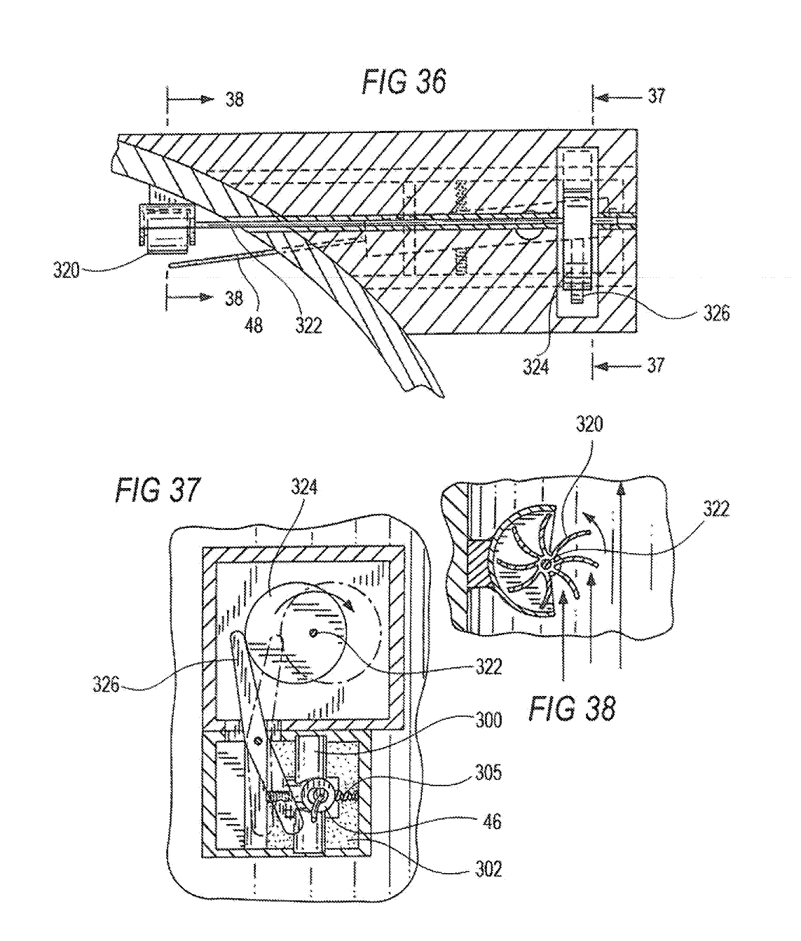

In yet another embodiment, when a laser ring is used on a smoke stack, as shown in FIGS. 36-38, a propeller 320 may be used to drive a shaft 322. The propeller is rotated by the gases passing through the smoke stack. An off center cam 324 is used to oscillate a laser gun 46 either directly or via a cam following arm 326.

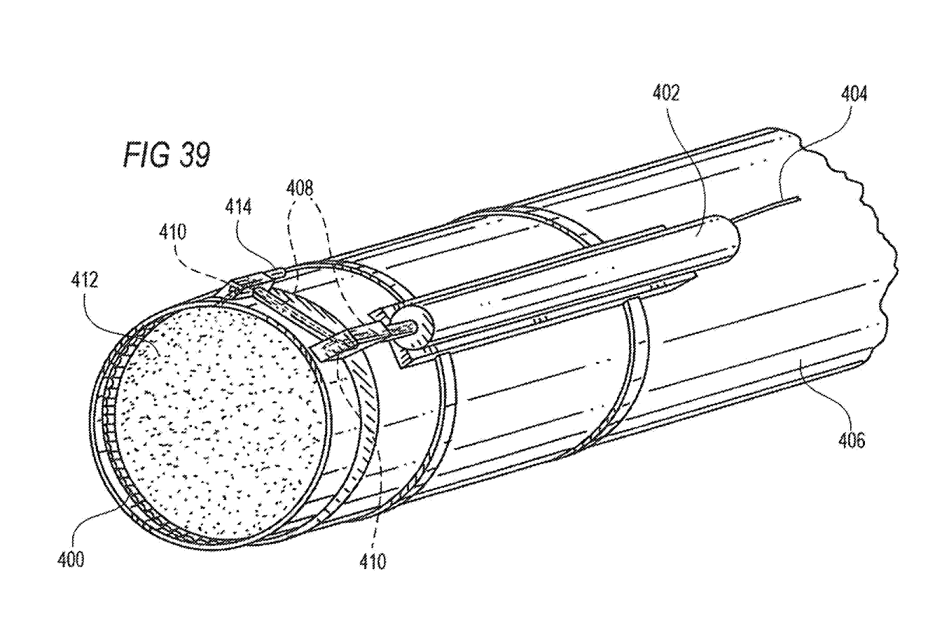

In the embodiments discussed above, a laser ring with a laser gun is disclosed in which the laser gun is oriented perpendicularly to the axis of the ring. In an alternate embodiment shown in FIG. 39, a laser ring 400 is provided with a laser gun 402 disposed in parallel with the ring's longitudinal axis. One or more mirrors are used to direct the laser beam inside the laser wall. More specifically, the laser gun 402 generates laser beans 408 that are directed by mirrors 410 at the inner laser wall 412. One or more of the mirrors 410 are oscillated by motor 414.

Numerous modifications may be made to the invention without departing from its scope as defined in the appended claims.

We claim:

1. A laser ring for eliminating pollutants produced by gases of a power plant, said gases being exhausted through an exhaust pipe, said laser ring comprising:
a laser ring housing having an inner surface, said laser ring housing being configured to intercept and receive said gases; and
a laser gun attached to said laser ring housing and arranged to generate a laser beam directed at said inner surface, said inner surface being arranged and constructed to reflect said laser beam through said gases and remove pollutants therefrom.

2. The laser ring of claim 1 wherein said inner surface forms an open chamber configured to be attached to said exhaust pipe.

3. The laser ring of claim 1 wherein said laser gun is adapted to generate said laser beam with an adjustable wavelength.

4. The laser ring of claim 1 wherein said laser gun is adapted to generate one of a continuous and a pulsed laser beam.

5. The laser ring of claim 1 further comprising an oscillating mechanism to oscillate the direction of said beam as said beam enters said laser ring housing.

6. The laser ring of claim 1 comprising multiple laser guns, each laser gun directing a respective laser beam into said housing.

7. The laser ring of claim 1 wherein said inner surface is formed with a plurality of reflective peaks.

8. The laser ring of claim 7 wherein said inner surface includes a plurality of concave blocks.

9. The laser ring of claim 7 wherein said inner surface includes a plurality of convex blocks.

10. The laser ring of claim 7 wherein said inner surface is formed with a plurality of subpeaks formed on said peaks.

11. The laser ring of claim 1 wherein said inner surface is a smooth highly reflective surface.

12. The laser ring of claim 1 further comprising a lens for shaping said laser beam into a wide beam.

13. The laser ring of claim 1 further comprising a plurality of laser guns, each laser gun generating a respective laser beam with different wavelengths.

14. The laser ring of claim 1 wherein said laser gun generates a cold laser beam.

15. The laser ring of claim 1 further comprising a mechanism for oscillating the laser gun, said mechanism including a motor and an offset cam rotated by said motor and arranged to oscillate said laser gun.

16. The laser ring of claim 1 further comprising a mechanism for oscillating the laser gun, said mechanism including a propeller driven by gases from the power plant, and an offset cam rotated by said propeller and arranged to oscillate said laser gun.

17. The laser ring of claim 1 wherein said housing is formed of sheet metal having a variable length to conform to a diameter of different stacks, and an inner mounting member selectively attaching a plurality of reflective blocks to said sheet metal to form said inner surface.

18. The laser ring of claim 1 further comprising at least one mirror reflecting the laser beam into said housing.

19. The laser ring of claim 18 further comprising a mechanism for selectively oscillating said mirror to direct said beam into said housing at different angles.
